(19) United States
(12) Patent Application Publication
(10) Pub. No.: US 2015/0071165 A1
(43) Pub. Date: Mar. 12, 2015

(54) SCALABLE WIRELESS ARCHITECTURE

(71) Applicant: VERIZON PATENT AND LICENSING INC., Arlington, VA (US)

(72) Inventor: Damascene M. Joachimpillai, Westford, MA (US)

(73) Assignee: VERIZON PATENT AND LICENSING INC., Arlington, VA (US)

(21) Appl. No.: 14/020,375

(22) Filed: Sep. 6, 2013

(51) Int. Cl. H04W 24/02

(52) U.S. Cl. CPC H04W 24/02; H04W 84/042
USPC 370/328

(57) ABSTRACT

Functionality relating to control and data plane functions in a telecommunications network may be separated. In one implementation, a telecommunications network may include a radio access network to provide a radio interface to mobile devices that connect to the telecommunications network. A first set of devices may implement functionality corresponding to control plane operations by the telecommunications network, the control plane operations including operations relating to establishing communication sessions in the telecommunications network. A second set of devices may implement functionality corresponding to data plane operations by the telecommunications network, the data plane operations including operations relating to transmitting user data over the established communication sessions.

### BACKGROUND

A telecommunications network, such as a wireless telecommunications network, may enable communications between users of mobile devices or other terminals that are connected to the telecommunication network. The telecommunications network may include nodes, connected by links, which transmit data through the telecommunications network, using, for example, packet switched routing.

An example of a telecommunications network is one implemented using the long term evolution (LTE) mobile communication standard. An LTE network may be based on an Internet Protocol (IP) system, in which all data is packet switched. Various nodes (e.g., network devices) in the LTE network may perform control, policy, and gateway functions for the LTE network. When implementing a telecommunications network, such as an LTE-based network, it may be desirable to use a network architecture that maximizes performance and minimizes cost.

### BRIEF DESCRIPTION OF THE DRAWINGS

FIGS. 1 and 2 illustrate an overview of concepts described herein;

FIG. 3 is a diagram of an example of a telecommunications network that may correspond to the telecommunications network illustrated in FIG. 1;

FIG. 4 is a diagram of an example of a telecommunications network that may correspond to the telecommunications network illustrated in FIG. 2;

FIG. 5 is a flow chart illustrating an example process for implementing a telecommunications network;

FIG. 6 is a flow chart illustrating an example process for scaling a telecommunications network; and

FIG. 7 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques described herein may provide for separation of control and data plane functions in a telecommunications network, such as an LTE network. For example, the functionality of some traditional network elements in an LTE network, such as a packet data network gateway (PGW), may be separated into a first portion that implements the functionality of the PGW with respect to control plane traffic and a second portion that implements the functionality of the PGW with respect to data plane traffic. Devices (e.g., routers, switches, servers, server clusters, etc.) that implement the control plane and data plane traffic may be separately installed, managed, and scaled. For example, devices to implement the control plane traffic may be implemented in a central control cluster (e.g., a cloud implementation, one or more computer servers or blades, etc.) that can be efficiently implemented and scaled.

Data plane traffic, as used herein, may refer to traffic associated with the substantive information that is being communicated by a user. Control plane traffic, as used herein, may refer to traffic associated with the establishing, billing, monitoring and/or analyzing of communication sessions in the data plane. As an example of the relationship of control and data plane traffic, control plane traffic may be used to establish a communication session in the telecommunications network. The communication session may then remain open for some time and be used to transmit data plane traffic (e.g., user data).

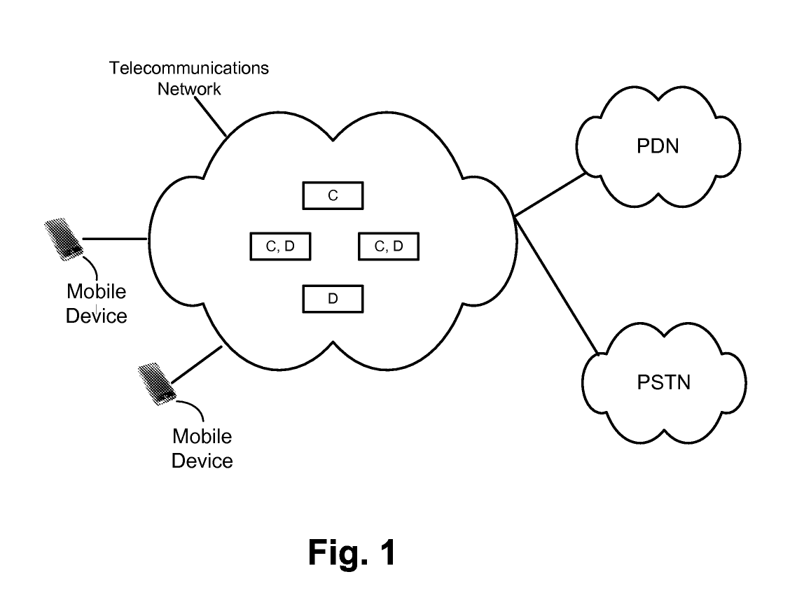

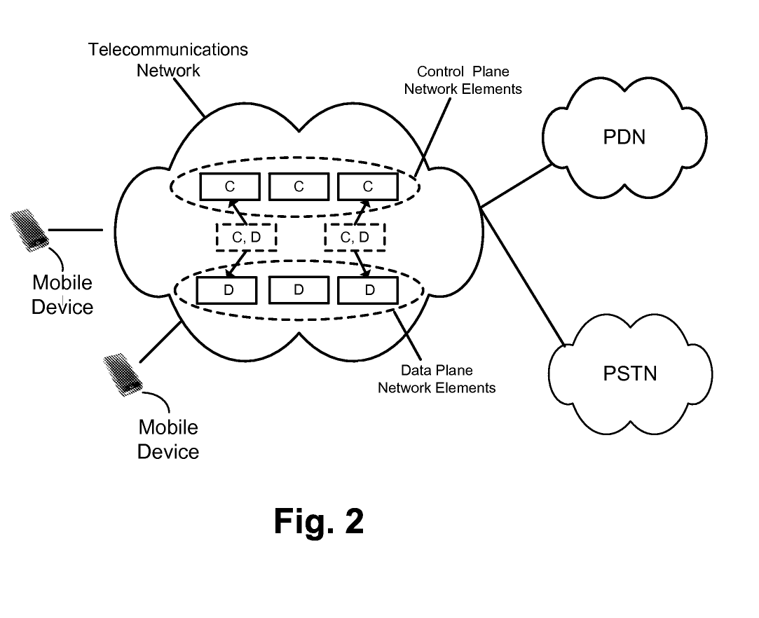

FIGS. 1 and 2 are diagrams conceptually illustrating an example of an overview of concepts described herein. FIG. 1 may illustrate a system using an architecture for a telecommunications system. FIG. 2 may illustrate a system using a network architecture for a telecommunications system consistent with aspects described herein.

As shown in FIG. 1, mobile devices, such as mobile phones, may connect to a telecommunications network, such as a cellular network, via a wireless (e.g., radio) interface. The telecommunications network may connect users of the mobile devices to one or more other end-users or end-services. For example, the telecommunications network may connect a mobile device to a public switched telephone network (PSTN) to complete a voice call with another user or to a packet data network (PDN) to connect to a web server or other service.

The telecommunications network may include a number of network elements that are used to implement the telecommunications network. For example, the telecommunications network may include base stations that provide radio interfaces with mobile devices, routers that provide routing and switching services for traffic in the telecommunications network, and other network elements that provide control or other functions for the telecommunications network. The network elements may be broadly classified as “control” elements that perform functions relating to control plane traffic in the telecommunications network and “data” elements that provide functions relating to data plane traffic in the telecommunications network.

In FIG. 1, a number of network elements are shown as rectangles within the telecommunications network. Some of the illustrated network elements (labeled as “D”) may primarily function to handle data plane traffic, other ones of the network elements (labeled as “C”) may primarily function to handle control plane traffic, and other ones of the network elements (labeled as “C, D”) may function to handle both control plane and data plane traffic.

Some mobile devices, such as machine-to-machine mobile devices, may tend to transmit data using primarily control plane traffic, while other mobile devices, such as smart phones used by consumers or mobile hotspot devices, may tend to use more data plane traffic. In the example of FIG. 1, the network elements that handle control and data plane traffic may generally be distributed throughout the network. This can be problematic, such as when it is desired to upgrade the capacity of the telecommunications network. For example, a network element that handles both control plane and data plane traffic (a “C, D” element) may still have capacity with respect to its operations relating to the data plane traffic but may be at maximum capacity with respect to its operations relating to the control plane traffic. The entire network element, however, may nevertheless need to be replaced to upgrade the data plane traffic capacity.

FIG. 2 may illustrate a system using a network architecture for a telecommunications system consistent with aspects described herein. As with FIG. 1, as illustrated in FIG. 2, mobile devices may connect, using a telecommunications network, to each other, devices or services associated with a PDN, or other devices associated with a PSTN.

In contrast to the telecommunications network illustrated in FIG. 1, in the telecommunications network illustrated in FIG. 2, the architecture of the telecommunications network may be implemented as separate network elements to handle control plane traffic and data plane traffic. For example, the functionality of the “C, D” network elements, as illustrated in FIG. 1, may be separated so that the data plane functionality and the control plane functionality may be implemented by separate network devices. From a functional perspective, however, the telecommunications network of FIG. 2 may be compatible with the telecommunications network of FIG. 1. In other words, the signaling protocols and the interfaces provided by the network elements may remain unchanged, such that the mobile devices, additional networks, and other network elements (i.e., network elements that are unchanged between FIGS. 1 and 2) may continue to operate without modification.

In some implementations, the control plane network elements illustrated in FIG. 2 may be implemented in a virtualized computing environment (e.g., a network “cloud”) or by a centralized or distributed server cluster. In this situation, adding or modifying capacity, associated with a particular control plane function, may be particularly cost-effective and/or efficient. Additionally, by separating the control plane and data plane, as illustrated in FIG. 2, network redundancy may be more easily obtained (e.g., control plane network elements that are vital to the operation of the telecommunications network may be redundantly implemented without having to implement data plane functionality that may not be as vital to the operation of the telecommunications network). Still further, by separating the control plane and data plane, as illustrated in FIG. 2, “best-in-breed” network elements, potentially provided by different vendors, may be separately chosen for the control plane network elements and the data plane network elements.

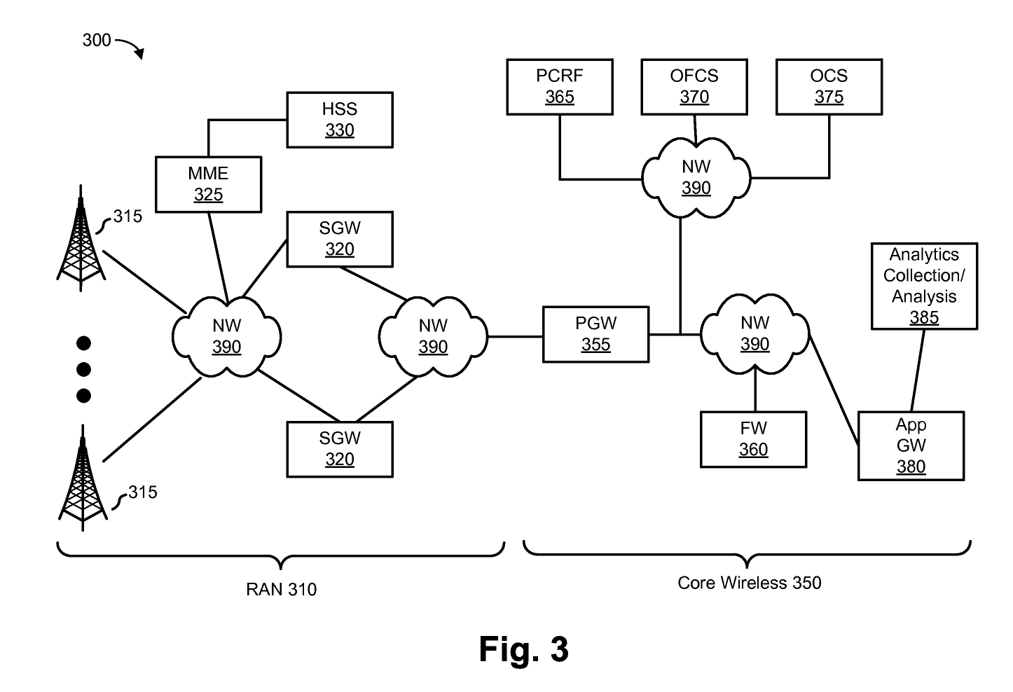

FIG. 3 is a diagram of an example of a telecommunications network that may generally correspond to the telecommunications network illustrated in FIG. 1 and may implement, for example, an LTE wireless network. Telecommunications network 300 may broadly include a radio access network (RAN) portion 310 and a core wireless portion 350.

RAN portion 310 may include one or more base stations 315, serving gateways (“SGW”) 320, mobility management entity devices (“MME”) 325, and home subscriber servers (“HSS”) 330. RAN portion 310 may generally provide and manage radio connections between mobile devices and telecommunications network 300. Core wireless portion 350 may include PGW 355, firewall (FW) 360, policy charging and rules function (“PCRF”) component 365, offline charging system (OFCS) component 370, online charging system (OCS) component 375, application gateway (GW) 380, and analytics collection/analysis component 385. Additionally, a number of networks (NW) 390 (and/or network links) may connect the various components shown in FIG. 3. Various ones of networks 390 may include, for example, high bandwidth backbone networks/links, local networks, Ethernet backhaul network, or other types of networks.

Base stations 315 may include one or more network devices that receive, process, and/or transmit traffic, such as calls, audio, video, text, television programming content, and/or other data, destined for and/or received from mobile devices. In the context of an LTE network, base stations 315 may be referred to as eNodeBs (eNBs). Base stations 315 may include antennas, radio control, and/or other logic to implement an air interface (e.g., radio interface) with mobile devices. Base stations 315 may communicate with SGWs 320 and MME 325 as part of the process of providing network connectivity to the mobile devices.

SGWs 320 may include one or more network devices to route and forward user traffic, from base stations 315, and may send the traffic to core wireless portion 350. SGWs 320 may act as a mobility anchor during handovers between base stations 315. SGWs 320 may also manage and store user equipment contexts and network internal routing information.

MME 325 may act as the key control node for RAN 310. For example, MME 330 may perform operations relating to registering mobile devices, to establishing bearer channels (i.e., data plane traffic sessions) associated with a mobile device, and/or to performing other operations. MME 330 may also perform policing operations on traffic destined for and/or received from mobile devices, and may be responsible for choosing a particular SGW 320 for a mobile device that is initially attaching to telecommunications network 300.

HSS 330 may act as a central database that contains user-related and subscription-related information. HSS 330 may include functionality that handles mobility management, call and session establishment support, user authentication and access authorization.

Core wireless portion 350 may generally act to provide transmission (e.g., long-distance “backhaul” transmission) of user data, provide access to external networks (e.g., a PDN), provide higher level policing and control functions, and provide access to advanced services (e.g., mobile device presence, multicast and broadcast, and other services). As mentioned, core wireless portion 350 may include, for example, PGW 355, firewall 360, PCRF component 365, OFCS component 370, OCS component 375, application gateway 380, and analytics collection/analysis component 385.

PGW 355 may include control and data plane stacks to communicate with SGWs 320. PGW 355 may aggregate traffic received from one or more SGWs 325, and may forward the traffic to firewall 360 and/or to external networks (e.g., an external PDN). In some situations, a mobile device may have simultaneous connectivity with more than one PGW 355 (e.g., for accessing multiple PDNs). PGW 355 may perform, for example, policy enforcement, per-user traffic filtering, charging support, lawful interception and traffic screening.

Firewall 360 may include one or more devices that provide functionality relating to network security, such as functionality relating to the analysis of traffic to determine whether the traffic should be allowed to pass or dropped. Firewall 360 may function in conjunction with PGW 355 to control the access of mobile devices, attached to RAN 310, to external networks (e.g., external PDNs).

PCRF component 365, OFCS component 370, and OCS component 375 may collectively operate to perform policy and control related functions. PCRF component 365 may include one or more devices or processes that may determine policy rules relating to mobile devices that connect to telecommunications network 300. PCRF component 365 may access subscriber databases and other user information stores regarding policies and/or subscriptions relating to mobile devices. OFCS component 370 may include one or more devices or processes that may provide for an offline (e.g., non-real time) interface that can be used to access charging information associated with telecommunications network 300. OCS component 375 may include one or more devices or processes that may provide for an online (e.g., real time) interface that can be used to access charging information and/or quota management information.

Application gateway 380 may include one or more devices that provide access to application servers (not shown) or other devices that provide services to mobile devices that access telecommunications network 300. The services may include, for example, multimedia services, device presence services, or other services. Application gateway 380 may monitor and/or track the use of the services or the traffic associated with the services. Analytics collection/analysis component 385 may receive the data from application gateway 380 and provide analytics and/or storage services based on the received data. For example, analytics collection/analysis component 385 may provide information, such as to network administrators, relating to the performance and/or usage of the services. Network administrators may use the information from analytics collection/analysis component 385 to enhance the operation of telecommunications network 300 and/or to obtain statistics relating to the operation of telecommunications network 300 (e.g., provide an indication of how many users are currently streaming video, etc.). In some implementations, application gateway 380 may be implemented as part of or within firewall 360.

The quantity of devices and/or networks, illustrated in FIG. 3, is provided for explanatory purposes only. In a practical implementation, there may be a number of additional devices. For example, a particular telecommunications network may include on the order of 50 PGWs 355 and firewalls 360. Additionally, in the particular telecommunications network, the policy and control related functions that are performed by PCRF component 365, OFCS component 370, and OCS component 375 may be performed by three sets of a PCRF component 365, OFCS component 370, and OCS component 375 (or on the order of three sets). Additionally, the particular network may include numerous base stations 315 and SGWs 320, but relatively few MMEs 325 and HSSs 330.

The various devices illustrated in FIG. 3 may communicate with one another using a number of interfaces, where an interface may refer to a set of protocols and/or application programming interfaces (APIs) that are used to exchange information between devices. A number of interface standards are known and may be used. For example, the known S5/S8 interface may be used between SGWs 320 and PGW 355; the known S1/S11 interface may be used by base stations 315 (e.g., to communicate with SGW 320 and MME 325); the known S6 interface may be used between MME 325 and HSS 330; and the known Gx, Rf, and Gy interfaces may be used to communicate with PCRF component 365, OFCS component 370, and OCS component 375, respectively.

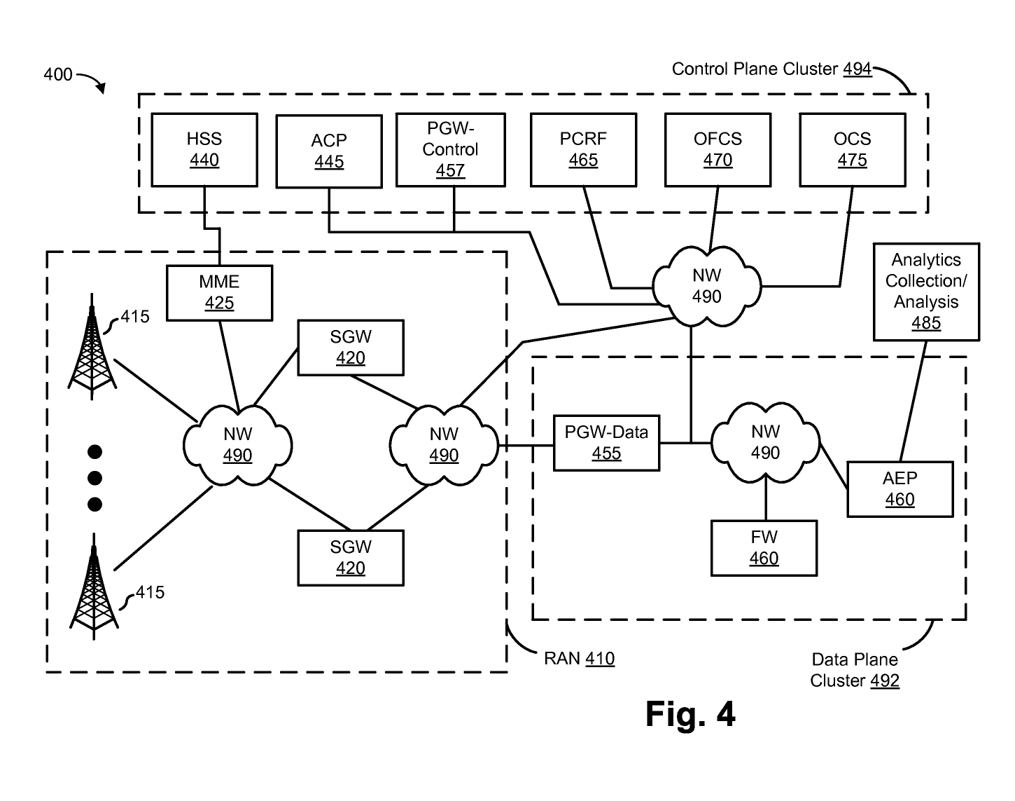

FIG. 4 is a diagram of an example of a telecommunications network that may generally correspond to the telecommunications network illustrated in FIG. 2 and may implement, for example, an LTE wireless network. In telecommunications network 400, functionality relating to the control plane of the LTE wireless network may be centralized and or combined at a single location, cluster, or cloud environment.

As illustrated, telecommunications network 400 may include base stations 415 and SGWs 420. Additionally, telecommunications network 400 may include MME 425, HSS 440, application control point (ACP) 445, PGW-Data 455, PGW-Control 457, firewall 460, PCRF component 465, OFCS component 470, OCS component 475, application enforcement point (AEP) 460, and analytics collection/analysis component 485. A number of networks 490 (and/or network links) may connect the various components shown in telecommunications network 400. As with networks 390, various ones of networks 490 may include, for example, high bandwidth backbone networks/links, local networks, or other types of networks.

In FIG. 4, base stations 415, SGWs 420, and MME 425 may correspond to a RAN, labeled as RAN 410, for telecommunications network 400. PGW-Data 455, firewall 460, and application gateway 480 may handle data plane traffic in telecommunications network 400, and may conceptually be thought of as data plane cluster 492. HSS 440, ACP 445, PGW-Control 457, PCRF component 465, OFCS component 470, and OCS component 475 may handle control plane traffic in telecommunications network 400, and may be conceptually thought of as control plane cluster 494.

RAN 410 may generally operate to provide a radio interface to mobile devices and to provide functionality relating to the management of the mobile devices with respect to the radio interface (e.g., handoffs between cells, etc.). With respect to RAN 410, base stations 415, SGWs 420, and MME 425 may function similarly to base stations 315, SGWs 320, and MME 325, respectively. MME 425, for example, may act as a control-node for resource management in RAN 410. MME 425 may perform operations to register mobile devices, to establish bearer channels (i.e., data plane traffic sessions) associated with a mobile device, and/or to perform other operations. MME 425 may communicate with HSS 440, in data plane cluster 492, such as via the S6 interface.

As previously mentioned, data plane cluster 492 may include PGW-Data 455, firewall 460, and AEP 460. Each of these network elements may implement functionality relating to processing of data plane traffic in telecommunications network 400. These network elements may be implemented using one or more network devices, such as routers, switches, high-bandwidth network devices, or other computing devices.

With respect to data plane cluster 492, firewall 460 may function similarly to firewall 360. PGW-Data 455 may include functionality corresponding to the data plane stack in PGW 355. For example, PGW-Data 455 may aggregate traffic received from one or more SGWs 420, and may forward the traffic to firewall 460 and/or to external networks (e.g., an external PDN). In some situations, a mobile device may have simultaneous connectivity with more than one PGW-Data 455 (e.g., for accessing multiple PDNs).

AEP 460 may include one or more devices that provide data-plane functionality with respect to the access of application servers (not shown) or other devices that provide services to mobile devices that access telecommunications network 400. The services may include, for example, multimedia services, device presence services, or other services. AEP 460 may monitor and/or track the use of the services or the traffic associated with the services. Analytics collection/analysis component 485 may receive the data from AEP 360 and provide analytics and/or storage services based on the received data. For example, analytics collection/analysis component 485 may provide information, such as to network administrators, relating to the performance and/or usage of the services. Network administrators may use the information from analytics collection/analysis component 485 to enhance the operation of telecommunications network 400. In some implementations, AEP 460 may be implemented as part of or within firewall 460.

As previously mentioned, control plane cluster 494 may include HSS 440, ACP 445, PGW-Control 457, PCRF component 465, OFCS component 470, and OCS component 475. Each of these components may implement functionality relating to processing of control plane traffic in telecommunications network 400. In one implementation, each of these components may correspond to a software process. The functionality of control plane cluster 494 may thus be implemented by, for example, a single server, multiple servers (e.g., blades or rack mounted servers), a scalable computing cloud or another scalable computing environment, etc. Adding (or removing) capacity from control plane cluster 494 may be thus be performed by increasing the processing capacity of a single (or a relatively few) computing environments.

HSS 440, PCRF component 465, OFCS component 470, and OCS component 475 may perform functions similar to HSS 340, PCRF component 365, OFCS component 370, and OCS component 375, respectively. ACP 445 may provide control-plane functionality with respect to the access of application servers (not shown) or other devices that provide services to mobile devices that access telecommunications network 400. ACP 445 may, for example, monitor, control, or define service policy with respect to control plane traffic. For example, ACP 445 may monitor and act on control plane traffic that relates to the initiation or tearing-down of control plane services. In some implementations, ACP 445 may provide information relating to the monitored control plane traffic to analytics collection/analysis component 485.

PGW-Control 457 may include functionality corresponding to the control plane stack in PGW 355. For example, PGW-Control 457 may perform, for example, operations with respect to control plane traffic that may provide for policy enforcement, per-user traffic filtering, charging support, lawful interception and traffic screening. PGW-Control 455 may, for instance, control or configure one or more network devices, such as PGW-Data 455, routers in one of networks 490, switches in one of networks 490, or other network elements.

Analytics collection/analysis component 485 may function similarly to analytics collection/analysis component 385. Analytics collection/analysis component 485 may, for example, receive data from AEP 460 and provide analytics and/or storage services based on the received data. For example, analytics collection/analysis component 485 may provide information, such as to network administrators, relating to the performance and/or usage of applications and/or services in telecommunications network 400. Network administrators may use the information from analytics collection/analysis component 485 to enhance the operation of telecommunications network 400 and/or to obtain statistics relating to the operation of telecommunications network 400 (e.g., provide an indication of how many users are currently streaming video, etc.).

The quantity of devices and/or networks, illustrated in FIG. 4, is provided for explanatory purposes only. In a practical implementation, there may be a number of additional devices. For example, a particular telecommunications network may include multiple data plane clusters 492, and/or a single data plane cluster 492 may include more than one PGW-Data 455, firewall 460, or AEP 460. Similarly, the particular telecommunications network may include multiple control plane clusters 494. In one possible implementation, a telecommunications network covering a large geographic area may include on the order of three control plane clusters 494 and 50 data plane clusters 492.

The various devices illustrated in FIG. 4 may communicate with one another using a number of standard interfaces. For example, the S5/S8 interface may be used between SGWs 420 and PGW-Data 455; the S1/S11 interface may be used by base stations 415 (e.g., to communicate with SGW 420 and MME 425); the S6 interface may be used between MME 425 and HSS 430; the Gx, Rf, and Gy interfaces may be used to communicate with PCRF component 465, OFCS component 470, and OCS component 475, respectively; and one or more of the GTP-C, Gx, Rf, Gy, and SDN control interfaces may be used to communicate with PGW-Control 457. In one implementation, SGW 420 may communicate with PGW-Control 457 and PGW-Data 455 using the GPRS Tunneling Protocol (GTP). For example, control plane traffic, communicated with PGW-Control 457, may be communicated using the GTP-C interface and data plane traffic, communicated with PGW-Data 455, may be communicated using the GTP-U interface.

Control and data plane traffic, as described above, may be separated into a control plane cluster and a data plane cluster in which devices in the data plane cluster handle substantially all of the non-RAN data traffic and devices in the control plane cluster handle substantially all of the non-RAN control plane traffic. By separating control plane traffic and data plane traffic, using the architecture described above for telecommunications network 400, complexity of the telecommunications network may be reduced relative to a traditional non-separated architecture. Additionally, telecommunications network 400 may be relatively easy to manage and scale. With respect to scaling of telecommunications network 400, computing hardware corresponding to data plane cluster 492 or control plane cluster 494 may be separately scaled, potentially allowing for a more cost-effective and finer-grain scaling of the hardware.

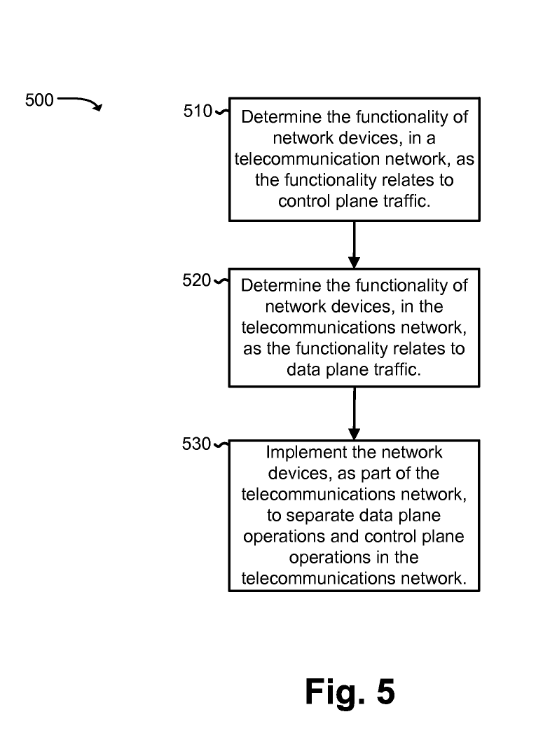

FIG. 5 is a flow chart illustrating an example process 500 for implementing a telecommunications network.

Process 500 may include determining the functionality of network devices, in a telecommunications network, as the functionality relates to control plane traffic (block 510). In an LTE network, such as the telecommunications network shown in FIG. 3, the various network devices (e.g., SGW 320, PGW 355, etc.) may be analyzed to determine the corresponding functionality of the network devices as the functionality relates to the processing of control plane traffic.

Process 500 may include determining the functionality of network devices, in the telecommunications network, as the functionality relates to data plane traffic (block 520). For example, the various network devices shown in FIG. 3 may be analyzed to determine the corresponding functionality of the network devices as the functionality relates to the processing of data plane traffic.

Process 500 may further include implementing the network devices, as part of the telecommunications network, to separate data plane operations and control plane operations in the telecommunications network (block 530). One example of a telecommunications network with separated data plane functionality and control plane functionality is illustrated in FIG. 4 and was discussed above.

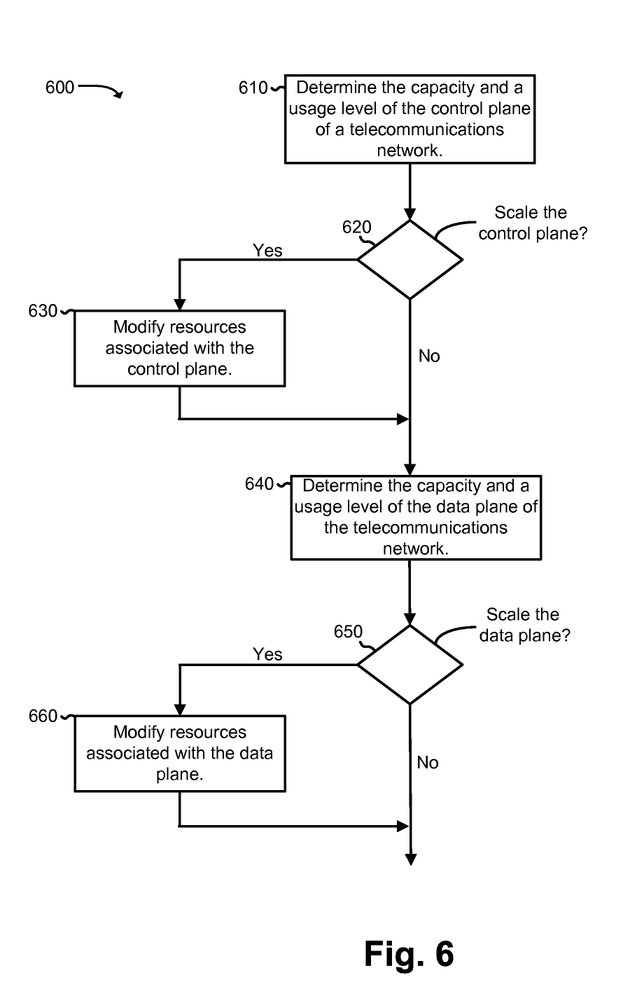

FIG. 6 is a flow chart illustrating an example process 600 for scaling a telecommunications network. Scaling a telecommunications network may refer to increasing or reducing the capacity of the telecommunications network. Process 600 may be implemented by, for example, an administrator, an automated process associated with control plane cluster 494, or a combination of a manual and automated process.

Process 600 may include determining the capacity and a usage level, such as the current usage level, of the control plane of a telecommunications network (block 610). For example, in situations in which control plane cluster 494 is implemented as a number of processes on a server, or server cluster (e.g., a set of processors or blades), the free processing capacity of the server or server cluster may be monitored as the difference between the capacity of the control plane and the current usage level.

Process 600 may further include determining, based on the usage level of the control plane and the capacity of the control plane, whether to scale the capacity of the control plane (block 620). For example, the free processing capacity of the server or server cluster, corresponding to the control plane, may fall below a predetermined threshold. In this situation, it may be desirable to add additional computing resources to the server or the server cluster. Alternatively or additionally, the free processing capacity of a server or the server cluster may rise above a second predetermined threshold. In this situation, to reduce costs or power consumption, it may be desirable to reduce an amount of computing resources that are dedicated to the server or the server cluster.

Process 600 may further include, when it is determined to scale the capacity of the control plane (block 620—YES), modifying resources associated with the control plane (block 630). As mentioned above, in situations in which control plane cluster 494 is implemented as one or more server devices, the capacity of control plane cluster 494 may be increased by adding server devices (or other computing resources) to the control plane cluster and decreased by removing server devices (or other computing resources) from the control plane cluster.

Process 600 may include determining the capacity and a usage level, such as the current usage level, of the data plane of the telecommunications network (block 640). For example, in situations in which data plane cluster 492 is implemented as a number of network elements, such as routers, servers, switches, or other network elements, the throughput, or another metric of capacity or usage level, of each network element, may be monitored.

Process 600 may further include determining, based on the usage level of the data plane and the capacity of the data plane, whether to scale the capacity of the data plane (block 650). For example, the available throughput of a particular network element may fall below a predetermined threshold. In this situation, it may be desirable to add additional network elements to the data plane. For example, additional routers, switches, or other network elements, such as network elements that implement PGW-Data 455, may be added to the data plane.

Process 600 may further include, when it is determined to scale the capacity of the data plane (block 650—YES), modifying resources (or potentially removing resources) associated with the data plane (block 660). For instance, an additional or higher capacity PGW-Data 455, firewall 460, and/or AEP 460 may be added.

As described above, with respect to FIG. 6, resources and/or devices associated with the control plane of a telecommunications network may be separately scaled or modified with respect to the resources and/or devices associated with the data plane of the telecommunications network.

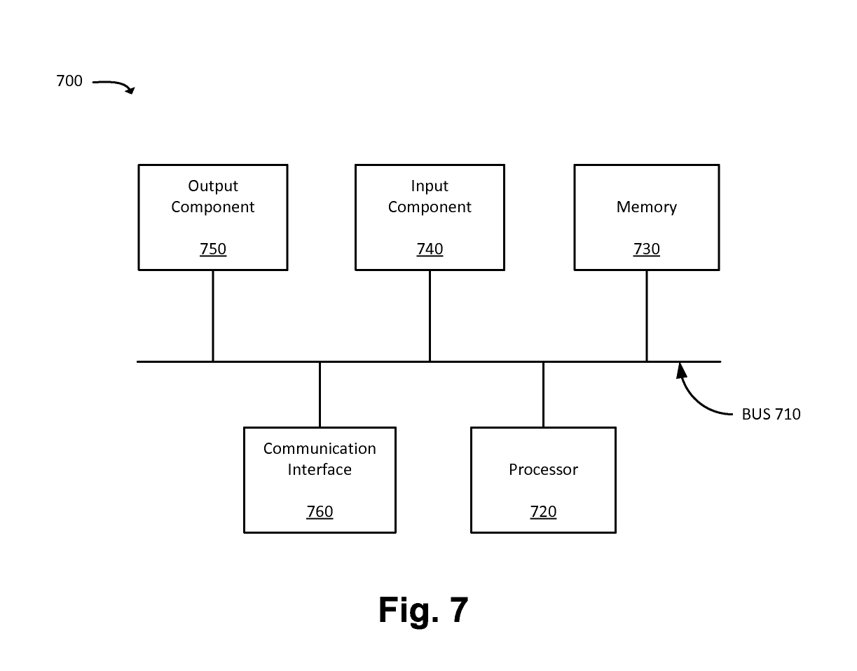

FIG. 7 is a diagram of example components of a device 700. Each of the devices illustrated in FIGS. 1-4 may include one or more devices 700. Device 700 may include bus 710, processor 720, memory 730, input component 740, output component 750, and communication interface 760. In another implementation, device 700 may include additional, fewer, different, or differently arranged components. Some non-limiting examples of device 700, with additional and/or different components, are discussed below.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more light emitting diodes (“LEDs”), etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to the operations described herein. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with regard to FIGS. 5 and 6, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an ASIC or a FPGA, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A telecommunications network comprising:
a radio access network to provide a radio interface to mobile devices that connect to the telecommunications network;
a control plane cluster including one or more computing devices to implement functionality relating to processing of control plane traffic in the telecommunications network, the functionality relating to the processing of the control plane traffic including functionality associated with control plane processing of a packet data network gateway (PGW); and
a data plane cluster including one or more network elements relating to processing of data plane traffic in the telecommunications network, at least one of the one or more network elements including functionality associated with data plane processing of the PGW,
wherein the one or more computing devices of the control plane cluster and the one or more network elements of the data plane cluster are different from one another.

2. The telecommunications network of claim 1, wherein the functionality associated with control plane processing of the PGW includes functionality associated with policy enforcement, per-user traffic filtering, charging support, lawful interception or traffic screening.

3. The telecommunications network of claim 1, wherein the functionality associated with data plane processing of the PGW includes functionality associated with aggregation and forwarding of traffic associated with the mobile devices.

4. The telecommunications network of claim 1, wherein the telecommunications network includes a Long Term Evolution (LTE) network.

5. The telecommunications network of claim 4, wherein the functionality relating to the processing of the control plane traffic additionally includes functionality of a home subscriber server (HSS) in the LTE network and a policy charging and rules function (“PCRF”) component in the LTE network.

6. The telecommunications network of claim 4, wherein the functionality relating to the processing of the control plane traffic additionally includes functionality of a offline charging system (OFCS) component in the LTE network and an online charging system (OCS) component in the LTE network.

7. The telecommunications network of claim 4, wherein at least one of the one or more network elements relating to processing of data plane traffic in the telecommunications network includes a firewall.

8. A system comprising:
a radio access network (RAN) to provide a radio interface to mobile devices that connect to a telecommunications network;
a first set of devices to implement functionality corresponding to substantially all non-RAN control plane operations by the telecommunications network, the control plane operations including operations relating to establishing communication sessions in the telecommunications network; and
a second set of devices to implement functionality corresponding to substantially all non-RAN data plane operations by the telecommunications network, the data plane operations including operations relating to transmitting user data over the established communication sessions,
wherein the first set of devices and the second set of devices are different from one another.

9. The system of claim 8, wherein the telecommunications network includes a Long Term Evolution (LTE) network.

10. The system of claim 9, wherein the control plane operations, implemented by the first set of devices, further includes functionality relating to control plane processing of a packet data network gateway (PGW) in the telecommunications network.

11. The system of claim 10, wherein the control plane processing of the PGW further includes functionality associated with policy enforcement, per-user traffic filtering, charging support, lawful interception or traffic screening.

12. The system of claim 10, wherein the control plane operations, implemented by the first set of devices, further includes functionality relating to functionality of a home subscriber server (HSS) in the LTE network and a policy charging and rules function (“PCRF”) component in the LTE network.

13. The system of claim 9, wherein the data plane operations, implemented by the second set of devices, further includes functionality associated with data plane processing of a packet data network gateway (PGW) in the telecommunications network.

14. The system of claim 13, wherein the functionality associated with the data plane processing of the PGW includes functionality associated with aggregation and forwarding of traffic associated with the mobile devices.

15. The system of claim 13, wherein at least one of the second set of devices includes firewall.

16. A method, implemented by one or more devices, comprising:
determining, by the one or more devices, a capacity and a usage level associated with one or more computing devices that implement processing of control plane traffic in a telecommunications network;
modifying, by the one or more devices and based on the determined capacity and the usage level associated with the one or more computing devices, computing resources corresponding to the one or more computing devices;
determining, by the one or more devices, a capacity and a usage level associated with one or more network devices that implement processing of data plane traffic in the telecommunications network; and
modifying, based on the determined capacity and the usage level associated with the one or more network devices, network resources associated with the one or more network devices,
wherein the one or more computing devices and the one or more network devices are different from one another, and
wherein the modification of the computing resources and the network resources are performed independently of one another.

17. The method of claim 16, wherein modifying the computing resources corresponding to the one or more computing devices further includes:
modifying the computing resources to increase a processing capacity of the computing resources when a free capacity of the one or more computing devices, determined based on the capacity and the usage level associated with the one or more computing devices being below a threshold.

18. The method of claim 16, wherein the one or more computing devices include a server or a server cluster.

19. The method of claim 16, wherein modifying the network resources associated with the one or more network devices further includes:
adding or replacing network devices, to increase a capacity of the one or more network devices, based on a free capacity of the one or more network devices, determined based on the capacity and the usage level associated with the one or more network devices being below a threshold.

20. The method of claim 16, wherein the one or more network devices include a router or switch.
